(19) United States
(12) Patent Application Publication
(10) Pub. No.: US 2023/0136197 A1
(43) Pub. Date: May 4, 2023

(54) VIBRATION ISOLATION FOR VEHICLE SEAT COMPONENTS

(71) Applicant: Toyota Motor Engineering & Manufacturing North America, Inc., Plano, TX (US)

(72) Inventors: Paul A. Gilmore, Ann Arbor, MI (US); Umesh N. Gandhi, Farmington Hills, MI (US); Ryohei Tsuruta, Ann Arbor, MI (US); Brian J. Pinkelman, Ann Arbor, MI (US); Mark A. Gummin, Silverton, OR (US); Brian J. Stasey, Fishers, IN (US)

(73) Assignees: Toyota Motor Engineering & Manufacturing North America, Inc., Plano, TX (US); Miga Technologies, LLC, Silverton, OR (US)

(21) Appl. No.: 17/514,075

(22) Filed: Oct. 29, 2021

(51) Int. Cl. B60N 2/50; B60N 2/02; B60N 2/54

(52) U.S. Cl. CPC B60N 2/501; B60N 2/0224; B60N 2/544

(57) ABSTRACT

Vibration isolation for vehicle seat components can be provided and/or can be adjustable. A vehicle seat can include a seat portion. The seat portion can include a seat cushion and/or a seat pan. In some arrangements, one or more shape memory material members can be provided. The seat cushion can be supported by the one or more shape memory material members. The one or more shape memory material members can be configured to have selectively variable stiffness. In some arrangements, one or more super elastic wires can be provided. The one or more super elastic wires can be operatively connected to one or more structures such that the seat pan is suspended on the one or more super elastic wires.

### FIELD

The subject matter described herein relates in general to vehicles and, more particularly, to vehicle seats.

### BACKGROUND

A vehicle typically includes a plurality of seats. There are numerous vehicle seat designs. Vehicles seats can be configured to provide support and comfort to a vehicle occupant. Some seats can include various ergonomic features to enhance user comfort. Some vehicle seats are powered and allow a user to adjust one or more aspects of the seat.

### SUMMARY

In one respect, the present disclosure is directed to a system for adjusting vibration isolation for a vehicle seat. The system can include a vehicle seat. The vehicle seat can include a seat portion. The seat portion can include a seat cushion. The system can include one or more shape memory material members. The seat cushion can be supported by the one or more shape memory material members. The one or more shape memory material members can be configured to have selectively variable stiffness.

In another respect, the present disclosure is directed to a method for adjusting vibration isolation of a vehicle seat. The vehicle seat can include a seat portion. The seat portion can include a seat cushion. The seat portion can include one or more shape memory material members. The seat cushion can be supported by the one or more shape memory material members. The method can include selectively varying the stiffness of the one or more shape memory material members.

In still another respect, the present disclosure is directed to a system for vibration isolation of a vehicle seat. The system can include a vehicle seat. The vehicle seat can include a seat pan. The system can include one or more super elastic wires. The one or more super elastic wires can be operatively connected to one or more structures such that the seat pan is suspended on the one or more super elastic wires.

### BRIEF DESCRIPTION OF THE DRAWINGS

FIG. 1 is an example of a vehicle seat system.

FIG. 2 is an example graph of stress-strain curves for a shape memory material member at different temperatures.

FIG. 3 is an example of a cross-sectional elevation view of a seat portion of a vehicle seat, showing a seat cushion supported on one or more shape memory material members.

FIG. 4 shows a top view of the seat portion of the vehicle seat, showing an example of an arrangement of a plurality of shape memory material members for supporting the seat cushion.

FIG. 5 is an example of a vehicle seat.

FIG. 6 is an example of a cross-sectional elevation view of a seat portion of a vehicle seat, showing a seat pan supported on one or more super elastic wires.

FIG. 7 is an example of a top view of the seat portion of the vehicle seat, showing an example of an arrangement of a plurality of super elastic wires.

FIG. 8 is an example of a stress-strain curve for a super elastic material.

### DETAILED DESCRIPTION

While a vehicle is in use, there are various forces that act upon the vehicles. These forces may be transmitted from the vehicle chassis to seats where the occupants are sitting, which may be felt by the occupants as vibration. Some vibrations can be especially irritating to vehicle occupants.

Thus, arrangements described here are directed to reducing the transfer of road vibrations to vehicle occupants. Arrangements described herein can use one or more shape memory material members. In some arrangements, a seat cushion can be supported by the one or more shape memory material members, which can be configured to provide selectively variable stiffness. In other arrangements, a seat pan can be suspended on the one or more super elastic wires. As a result of these arrangements, vibration isolation can be achieved.

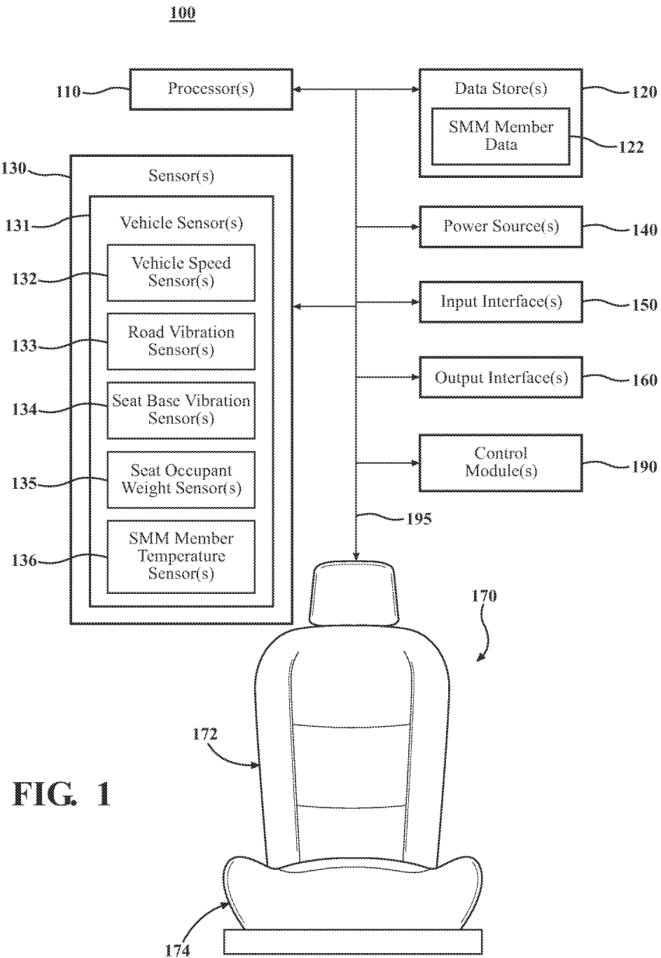

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Some arrangements will now be described with respect to FIGS. 1-4. In these arrangements, a cushion of a vehicle seat can be suspended from one or more shape memory material members. The stiffness of the shape memory material member(s) can be temperature dependent. Thus, the temperature of the shape memory material member(s) can be controlled (e.g., heated and/or cooled) to dynamically change their stiffness characteristics to isolate vibration of the seat.

Referring to FIG. 1, an example of a system 100 for a vehicle seat is shown. The system 100 can be used in connection with any type of vehicle. As used herein, “vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft or any other form of transport.

The system 100 can include various elements. Some of the possible elements of the system 100 are shown in FIG. 1 and will now be described. It will be understood that it is not necessary for the system 100 to have all of the elements shown in FIG. 1 or described herein. The system 100 can have any combination of the various elements shown in FIG. 1. Further, the system 100 can have additional elements to those shown in FIG. 1. In some arrangements, the system 100 may not include one or more of the elements shown in FIG. 1. Further, while the various elements may be located on or within a vehicle, it will be understood that one or more of these elements can be located external to the vehicle. Thus, such elements are not located on, within, or otherwise carried by the vehicle. Further, the elements shown may be physically separated by large distances. Indeed, one or more of the elements can be located remote from the vehicle.

The system 100 can include one or more processors 110, one or more data stores 120, one or more sensors 130, one or more power sources 140, one or more input interfaces 150, one or more output interfaces 160, one or more seats 170, and one or more control modules 190. Each of these elements will be described in turn below.

As noted above, the system 100 can include one or more processors 110. “Processor” means any component or group of components that are configured to execute any of the processes described herein or any form of instructions to carry out such processes or cause such processes to be performed. The processor(s) 110 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors can work in combination with each other. In one or more arrangements, one or more processors 110 can be a main processor(s) of a vehicle. For instance, one or more processors 110 can be electronic control unit(s) (ECU).

The system 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

In some arrangements, the data store(s) 120 can store shape memory material data 122 about one or more shape memory material members. As an example, the data store(s) 120 can store stress-strain curves for one or more shape memory material members, such as any of those used in the system 100. For each shape memory material member, the stress-strain curves can show the performance of the respective shape memory material member at different temperatures.

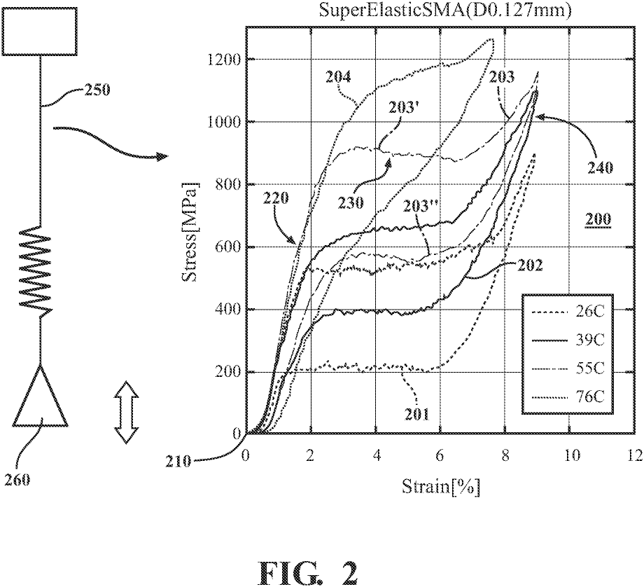

Referring to FIG. 2, a graph 200 showing example stress-strain curves for a shape memory material member is shown. The graph 200 can be for an example shape memory material member 250 under a load 260. The stress-strain curves can beat a plurality of different temperatures. In this example, stress-strain curves 201, 202, 203, 204 are shown for 26° C., 39° C., 55° C., and 76° C., respectively. It is noted that the graph 200 is merely an example, as the values will vary depending on various characteristics of each particular shape memory material member.

Stiffness of the shape memory material member can be temperature dependent. As a result, the stiffness characteristics of the shape memory material member can change with changes in temperature. The general shape of the stress-strain curves 201, 202, 203, 204 can represent the stiffness profile of the shape memory material member at different temperatures. As an example, the stress-strain curve 203 will be described. Starting from the origin 210, the shape memory material member can exhibit an initial stiffness region 220 that is substantially linear. The shape memory material member can be relatively stiff in the initial stiffness region 220. When load is reached, the stress-strain curve 203 can become zero or substantially zero, which is a quasi-zero stiffness region 230. The quasi-zero stiffness region 230 can allow for good vibration isolation. Continuing beyond the quasi-zero stiffness region 230, the stress-strain curve 203 can have a subsequent stiffness region 240 that is substantially linear. The shape memory material member can be relatively stiff in the subsequent stiffness region 240.

The stress-strain curve 203 has a first portion 203′ and a second portion 203″. The first portion 203′ represents the shape memory material member going from a non-loaded state to a loaded state. A second portion 203″ represents the shape memory material member going from a loaded state to a non-loaded state.

It should be noted that, at each temperature, the shape memory material member exhibits the quasi-zero stiffness region at a different stress level. Thus, the appropriate stiffness profile can be selected for the shape memory material member based on real-time loading conditions.

Further, it is noted that, at some temperature levels, the stiffness characteristics of the shape memory material member may not be as desirable because the quasi-zero stiffness region may be lost. As an example, the stress-strain curve 204 does not include a quasi-zero stiffness region. Thus, for the example shape memory material member shown in FIG. 2, it may not be desirable to heat the shape memory material member beyond 55° C.

The system 100 can include one or more sensors 130. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 100 includes a plurality of sensors 130, the sensors can work independently from each other. Alternatively, two or more of the sensors can work in combination with each other. In such case, the two or more sensors can form a sensor network. The sensor(s) 130 can be operatively connected to the processor(s) 110, the data store(s) 120, and/or other elements of the system 100 (including any of the elements shown in FIG. 1).

The sensor(s) 130 can include any suitable type of sensor. Various examples of different types of sensors will be described herein. However, it will be understood that the embodiments are not limited to the particular sensors described.

The sensor(s) 130 can include one or more vehicle sensors 131. The vehicle sensor(s) 131 can detect, determine, assess, monitor, measure, quantify and/or sense information about a vehicle itself (e.g., position, orientation, speed, vibration, seat loading, etc.). In one or more arrangements, the vehicle sensors 131 can include one or more vehicle speed sensors 132, one or more road vibration sensors 133, one or more seat base vibration sensors 134, and/or one or more seat occupant weight sensors 135. The vehicle speed sensor(s) 132 can be any sensor configured to detect, determine, assess, monitor, measure, quantify and/or sense the speed of a vehicle, now known or later developed. The road vibration sensor(s) 133 can be any sensor, now known or later developed, configured to detect, determine, assess, monitor, measure, quantify and/or sense vibrations imparted on the vehicle by the road. The seat base vibration sensor(s) 134 can include any sensor, now know or later developed, configured to detect, determine, assess, monitor, measure, quantify and/or sense any information or data about vibrations imparted on a vehicle seat. The seat occupant weight sensor(s) 135 can include any sensor, now know or later developed, configured to detect, determine, assess, monitor, measure, quantify and/or sense any information or data about a weight of an occupant of a vehicle seat. In one or more arrangements, the vehicle sensors 131 can include one or more shape memory material member temperature sensors 136. The shape memory material member temperature sensor(s) 136 can be any sensor configured to detect, determine, assess, monitor, measure, quantify and/or sense the temperature of a shape memory material member, now known or later developed.

The sensor(s) 130 can include one or more environment sensors configured to detect, determine, assess, monitor, measure, quantify, acquire, and/or sense driving environment data. “Driving environment data” includes and data or information about the external environment in which a vehicle is located or one or more portions thereof. In one or more arrangements, the environment sensors can include one or more cameras, one or more radar sensors, one or more lidar sensors, one or more sonar sensors, and/or one or more ranging sensors.

As noted above, the system 100 can include one or more power sources 140. The power source(s) 140 can be any power source capable of and/or configured to energize the shape memory material members, as will be described later. For example, the power source(s) 140 can include one or more batteries, one or more fuel cells, one or more generators, one or more alternators, one or more solar cells, and combinations thereof.

The system 100 can include one or more input interfaces 150. An “input interface” includes any device, component, system, element or arrangement or groups thereof that enable information/data to be entered into a machine. The input interface(s) 150 can receive an input from a vehicle occupant (e.g. a driver or a passenger). Any suitable input interface 150 can be used, including, for example, a keypad, display, touch screen, multi-touch screen, button, joystick, mouse, trackball, microphone and/or combinations thereof.

The system 100 can include one or more output interfaces 160. An “output interface” includes any device, component, system, element or arrangement or groups thereof that enable information/data to be presented to a vehicle occupant (e.g. a person, a vehicle occupant, etc.). The output interface(s) 160 can present information/data to a vehicle occupant. The output interface(s) 160 can include a display. Alternatively or in addition, the output interface(s) 160 may include an earphone and/or speaker. Some components of the system 100 may serve as both a component of the input interface(s) 150 and a component of the output interface(s) 160.

The system 100 can include one or more seats 170. The seat(s) 170 can be for any vehicle occupants, such for a driver or for a passenger. The seat(s) 170 can be any type of vehicle seat, now known or later developed. The one or more seats 170 can have any suitable configuration. For instance, the one or more seats 170 can include a back portion 172 and a seat portion 174. The seat can include one or more shape memory material members. Additional details of the seat(s) 170 and the shape memory material member(s) will be described later.

The system 100 can include one or more modules, at least some of which will be described herein. The modules can be implemented as computer readable program code that, when executed by a processor, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively or in addition, one or more data stores 120 may contain such instructions.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 100 can include one or more control modules 190. The control module(s) 190 can include profiles and logic for actively controlling the stiffness characteristics of the shape memory material members of the vehicle seat 170. The control module(s) 190 can be configured to determine when the stiffness characteristics of the shape memory material members of the vehicle seat 170 should be adjusted. The control module(s) 190 can be configured to do so in any suitable manner. For instance, the control module(s) 190 can be configured to analyze data or information acquired by the sensor(s) 130 (e.g., the vehicle speed sensor(s) 132, the road vibration sensor(s) 133, the seat base vibration sensor(s) 134, the seat occupant weight sensor(s) 135, and/or other sensors). Alternatively or additionally, the control module(s) 190 can be configured to detect user inputs (e.g., commands) provided on the input interface(s) 150. The control module(s) 190 can retrieve raw data from the sensor(s) 130 and/or from the data store(s) 120. The control module(s) 190 can use profiles, parameters, or setting loaded into the control module(s) 190 and/or stored in the data store(s) 120, such as the shape memory material data 122.

The control module(s) 190 can analyze the sensor data to determine an appropriate action for the shape memory material members. The control module(s) 190 can be configured to cause the stiffness of the one or more shape memory material members to be adjusted. As used herein, “cause” or “causing” means to make, force, compel, direct, command, instruct, and/or enable an event or action to occur or at least be in a state where such event or action may occur, either in a direct or indirect manner. For instance, the control module(s) 190 can cause the shape memory material members to be selectively heated or cooled. As noted above, the stiffness of the shape memory material member is temperature dependent. The shape memory material members can be heated or cooled in any suitable manner, now known or later developed. For instance, shape memory material members can be heated by the Joule effect by passing electrical current through the shape memory material members. To that end, the control module(s) 190 can be configured to selectively permit, restrict, adjust, alter, and/or prevent the flow of electrical energy from the power source(s) 140 to the one or more shape memory material members associated with the vehicle seat 170. The control module(s) 190 can be configured send control signals or commands over a communication network 195 to the shape memory material members or to other elements of the system 100.

The control module(s) 190 can be configured to cause the stiffness characteristics of the shape memory material members associated with the vehicle seat portion 174 to be adjusted based on one or more parameters. For instance, the control module(s) 190 can be configured to cause the stiffness characteristics of the shape memory material members associated with the vehicle seat portion 174 to be adjusted based on real-time conditions as detected by the sensor(s) 130, such as seat occupant weight, road vibration, vehicle speed, seat base vibration, other conditions, or any combination thereof. Based on these real-time condition, the control module(s) 190 can determine suitable stiffness characteristics for the shape memory material member(s). The control module(s) 190 can query the data store(s) 120 for data about the shape memory material member(s). For instance, the control module(s) 190 can query the shape memory material data 122, such as the stress-strain curves for the shape memory material member(s). The control module(s) 190 can be configured to select or determine a target temperature for the shape memory material member(s) to achieve a desired stiffness characteristics. The target temperature can be based on one of the stress-strain curves, or it can be interpolated using the two stress-strain curves that bracket the desired stiffness characteristics.

Once a target temperature is selected, the control module(s) 190 can compare a current temperature of the shape memory material member(s), as determined by the shape memory material member temperature sensor(s) 136, to the target temperature. If the shape memory material member(s) need to be heated above their current temperature, then the control module(s) 190 can be configured to selectively permit or increase the flow of electrical energy from the power source(s) 140 to the shape memory material member(s) associated with the vehicle seat 170. If the shape memory material member(s) need to be cooled below their current temperature, then the control module(s) 190 can be configured to selectively decrease, restrict, or discontinue the flow of electrical energy from the power source(s) 140 to the shape memory material member(s) associated with the vehicle seat 170. In some arrangements, the control module(s) 190 can be configured to activate a cooling source (e.g., a fan, a blower, a cooler, etc.) to facilitate the cooling of the shape memory material member(s). If the current temperature of the shape memory material member(s) is substantially equal to the target temperature, then the control module(s) 190 can take any suitable action with respect to the flow of electrical energy from the power source(s) 140 to the shape memory material member(s) associated with the vehicle seat 170 so that the current temperature is maintained. The control module(s) 190 can be configured send control signals or commands over a communication network 195 to the shape memory material members.

In some instances, the control module(s) 190 can be configured to cause the stiffness characteristics of the shape memory material member(s) to be selectively adjusted based on user inputs (e.g., commands). For instance, a user can provide an input on the input interface(s) 150. The input can be to adjust the stiffness characteristics of the shape memory material member(s). The control module(s) 190 can be configured to cause the stiffness characteristics of the shape memory material member(s) to be adjusted in accordance with the user input.

The control module(s) 190 can be configured to control the stiffness characteristics of a plurality of seats 170. The control module(s) 190 can be configured to control the stiffness characteristics of each seat 170 individually. Thus, the adjustment of the stiffness characteristics of one seat 170 can be performed independently of the adjustment of the stiffness characteristics of the other seats 170. Alternatively, the control module(s) 190 can be configured to control the stiffness characteristics of a plurality of seat(s) 170 collectively. Thus, the stiffness characteristics of each seat 170 can be adjusted at substantially the same time, to the same degree of actuations, and/or in substantially the same manner.

The various elements of the system 100 can be communicatively linked to one another or one or more other elements through one or more communication networks 195. As used herein, the term “communicatively linked” can include direct or indirect connections through a communication channel, bus, pathway or another component or system. A “communication network” means one or more components designed to transmit and/or receive information from one source to another. The data store(s) 120 and/or one or more other elements of the system 100 can include and/or execute suitable communication software, which enables the various elements to communicate with each other through the communication network and perform the functions disclosed herein.

The one or more communication networks 195 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

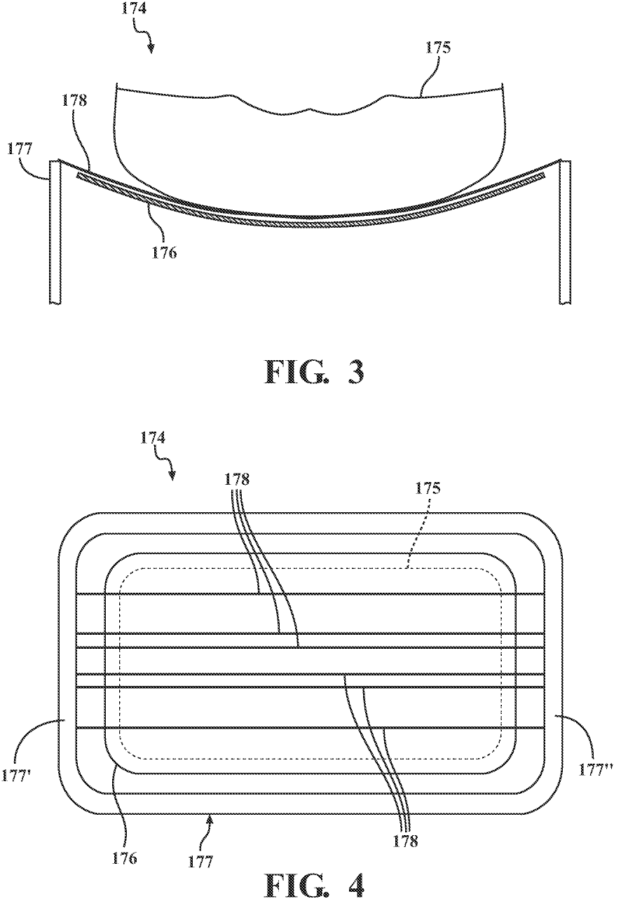

Referring to FIGS. 3 and 4, an example of the seat portion 174 of the vehicle seat 170 is shown. FIG. 3 is an example of a cross-sectional elevation view of a seat portion of the vehicle seat 170, and FIG. 4 shows a top view of the seat portion of the vehicle seat 170.

The seat portion 174 can include a seat cushion 175. The seat cushion 175 can be made of any suitable material, now known or later developed. For instance, the seat cushion 175 can be made of a foam material. The seat cushion 175 can include an outer covering, such as fabric or leather. The seat cushion 175 can have any suitable size, shape, and/or configuration. In some arrangements, the seat cushion 175 can include bolsters.

In some arrangements, the seat portion 174 can include a seat pan 176. The seat pan 176 can have any suitable size, shape, and/or configuration. As an example, the seat pan 176 can be a substantially U-shaped structure. The seat pan 176 can be oriented such that it opens in a substantially upward direction. The seat pan 176 can be made of any suitable material. In one or more arrangements, the seat pan 176 can be made of a rigid material. For example, the seat pan 176 can be made of metal or plastic.

In one or more arrangements, the seat pan 176 can at least partially support the seat cushion 175. In one or more arrangements, the seat pan 176 may not be attached to the seat cushion 175. In one or more arrangements, a portion of the seat cushion 175 can be received in the seat pan 176.

In some arrangements, the seat portion 174 can include a seat frame 177. The seat frame 177 can be made of any suitable material. In one or more arrangements, the seat frame 177 can be made of a rigid material. For example, the seat frame 177 can be made of metal or plastic. In some arrangements, the seat frame 177 can be part of or operatively connected to a vehicle frame member or to a vehicle floor.

In one or more arrangements, the seat frame 177 can at least partially support the seat pan 176 in any suitable manner, now known or later developed. In one or more arrangements, a portion of the seat pan 176 can be received in the seat frame 177.

The seat frame 177 can have any suitable size, shape, and/or configuration. As an example, the seat frame 177 can be a substantially U-shaped structure. As another example, the seat frame 177 can be a substantially rectangular structure, as is shown in FIG. 4. The seat frame 177 can be oriented such that it opens in a substantially upward direction. In one or more arrangements, the seat frame 177 can include a first end portion 177′ and a second end portion 177′. As another example, the seat frame 177 can be made of a plurality of individual posts.

The seat portion 174 can include one or more shape memory material members 178. When there is a plurality of the shape memory material members 178, the shape memory material members 178 can be substantially identical to each other, or one or more of the shape memory material members 178 can be different from the other shape memory material members 178 in one or more respects. The ends or end regions of the shape memory material members 178 can be operatively connected to any suitable structure. For instance, in some arrangements, the ends or end regions of the shape memory material members 178 can be operatively connected to portions of the seat frame 177. In other arrangements, the ends or end regions of the shape memory material members 178 can be operatively connected to portions of the seat pan 176.

The ends or end regions of the shape memory material members 178 can be operatively connected to structures in any suitable manner, including by one or more fasteners, one or more adhesives, one or more welds, one or more forms of mechanical engagement, and/or one or more structures, just to name a few possibilities.

The shape memory material members 178 can span across the structure to which they are connected (e.g., the seat frame 177, the seat pan 176, etc.) in any suitable manner. For instance, the shape memory material members 178 can span across the structure in a widthwise direction (corresponding to the left-right direction of the vehicle), in a lengthwise direction (corresponding to the front-back direction of the vehicle), in some other direction, or any combination thereof.

The seat cushion 175 can be suspended on shape memory material members 178 extending across the seat frame. In some arrangements, the seat cushion 175 can be suspended exclusively on the shape memory material members 178. The shape memory material members 178 can provide stiffness in support of the weight of a vehicle occupant sitting on the seat 170.

The shape memory material members 178 can be generally located between the seat pan 176 and the seat cushion 175. The shape memory material members 178 can be arranged in various ways. A non-limiting example of one arrangement is shown in FIG. 4, which shows a top view of the seat portion 174. The seat cushion 175 is shown in dashed lines for clarity. In one or more arrangements, a plurality of the shape memory material members 178 can be arranged in a substantially parallel manner. In some arrangements, the shape memory material members 178 can be substantially equally spaced from each other. In other arrangements, the shape memory material members 178 can be non-equally spaced from each other. In some arrangements, two or more of the shape memory material members 178 can cross each other. In some arrangements, one or more of the shape memory material members 178 can be arranged in a serpentine manner.

The shape memory material members 178 can be operatively connected to the power source(s) 140. The shape memory material members 178 can be activated independently of each other. Alternatively or additionally, the shape memory material members 178 can be activated together as a group.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material member(s) 178 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 90 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members 178 to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni-Ti, or nitinol). One example of a nickel-titanium shape memory alloy is FLEXINOL, which is available from Dynaolloy, Inc., Irvine, California. As further example, the SMA wires can be made of Cu-Al-Ni, Fe-Mn-Si, or Cu-Zn-Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austentite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

In one or more arrangements, the shape memory material member(s) 178 can be made of super elastic materials. A super elastic material is a material that exhibits two primary properties under certain conditions: superelasticity and quasi-zero stiffness. These properties are depicted in the stress-strain curve 800 shown in FIG. 8. Superelasticity refers to the ability of the super elastic material to substantially regain its original shape when an applied stress, load, and/or force, is removed. For example, the super elastic recovery region 802 of the stress-strain curve 800 shows the super elastic material returning to a zero-stress state after unloading of an applied stress. Quasi-zero stiffness refers to a region of the stress-strain curve 800 for super elastic materials that is substantially flat. In the quasi-zero stiffness region 804 of the stress-strain curve 800, the stiffness becomes very low (for example, zero or substantially zero), which can allow for good vibration isolation. When the super elastic materials operate in the quasi-zero stiffness region 804, the transfer of vibrations (e.g., from the vehicle floor to the vehicle seat) can be substantially reduced. In this way, a super elastic material can act as a vibration isolator. The super elastic material would exhibit a similar profile on a force-deflection curve. In the quasi-zero stiffness region, the force-deflection curve can become substantially flat.

The shape memory material member(s) 178 can be made of any suitable super elastic material. One example of a super elastic wire is AdrenaLine®, which is available from Miga Motor Company, Silverton, Oregon. Another example of a super elastic wire is Furukawa Ni-Ti Alloy, which is available from Furukawa Techno Material Co., Ltd., Kanagawa, Japan. In other examples, the super elastic material can be shape memory alloy.

Other active materials may be used in connected with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the plurality of shape memory material members are described, in one implementation, as being wires, it will be understood that the plurality of shape memory material members are not limited to being wires. Indeed, it is envisioned that suitable shape memory materials may be employed in a variety of other forms, such as strips, small sheets or slabs, cellular and lattice structures, helical or tubular springs, braided cables, tubes, or combinations thereof. In some arrangements, the plurality of shape memory material members may include an insulating coating.

Now that the various potential systems, devices, elements and/or components of the system 100 have been described, an example of a method of dynamically adjusting the stiffness of a shape memory material member to isolate vibration of a vehicle seat will be described. The method described may be applicable to the arrangements described above in connection with FIGS. 1-4, but it is understood that the methods can be carried out with other suitable systems and arrangements. For purposes of discussion, the vehicle seat 170 can include the seat portion 174. The seat portion 174 can include the seat cushion 175, the seat pan 176, and one or more shape memory material members 178. The seat cushion 175 can be supported by the shape memory material member(s) 178.

The stiffness of the shape memory material member(s) can be selectively varied. Such selective varying can be performed in any suitable manner. For instance, a temperature of the shape memory material member(s) 178 can be controlled. In some arrangements, the control module(s) 190, the processor(s) 110, and/or one or more sensor(s) 130 can control the temperature of the shape memory material member(s) 178 by controlling the supply of electrical energy to the shape memory material member(s) 178.

In one or more arrangements, the control module(s) 190, the processor(s) 110, and/or one or more sensor(s) 130 can be configured to determine a target temperature for the shape memory material member(s) 178 to achieve a target stiffness profile for the shape memory material member(s) 178. Such a determination can be made based on real-time conditions and can include information about the shape memory material member(s) 178, as stored in the data store(s) 120 (e.g., the shape memory material data 122). A current temperature of the shape memory material member(s) 178 can be determined, such as by using data acquired by the shape memory material member temperature sensors 136. The control module(s) 190, the processor(s) 110, and/or one or more sensor(s) 130 can be configured to compare the current temperature of the shape memory material member(s) to a target temperature for the shape memory material member(s) 178. When the current temperature of the shape memory material member(s) 178 is different than the target temperature for the shape memory material member(s) 178, the control module(s) 190, the processor(s) 110, and/or one or more sensor(s) 130 can be configured to cause the supply of electrical energy (e.g., from the power source(s) 140) to the shape memory material member(s) 178 to be adjusted. As a result, the stiffness of the shape memory material member(s) 178 can be selectively varied. When the current temperature of shape memory material member(s) 178 is substantially equal to the target temperature for the shape memory material member(s) 178, the control module(s) 190, the processor(s) 110, and/or one or more sensor(s) 130 can be configured to take no action.

The selective varying can be performed at any suitable time. For instance, the selective varying can be performed on a continuously, periodically, irregularly, or even randomly. In some arrangements, the selective varying can be performed in response to a command (e.g., as provided on the input interface(s) 150) and/or in response to an event or condition(s).

It will be appreciated that arrangements described herein can provide numerous benefits, including one or more of the benefits mentioned herein. For example, arrangements described herein can improve the vibration performance of a vehicle seat. Arrangements described here can improve comfort of a seat occupant. Arrangements described herein can adjust the vibration isolation performance of the vehicle seat in real-time based on current conditions.

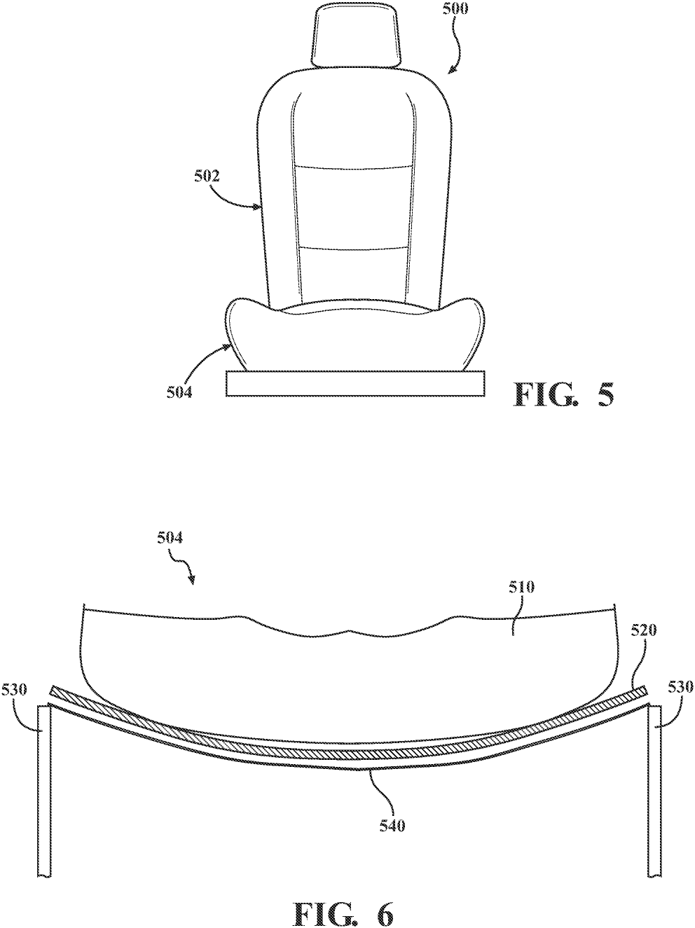

Some arrangements will now be described with respect to FIGS. 5-8. Referring to FIG. 5 an example of a vehicle seat 500 is shown. The vehicle seat 500 can be for use in connection with a vehicle. The vehicle seat 500 can be for any vehicle occupant, such for a driver or for a passenger. The vehicle seat 500 can be any type of vehicle seat, now known or later developed. The vehicle seat 500 can have any suitable configuration. For instance, the vehicle seat 500 can include a back portion 502 and a seat portion 504. According to arrangements herein, the vehicle seat 500 can be configured to isolate vibration.

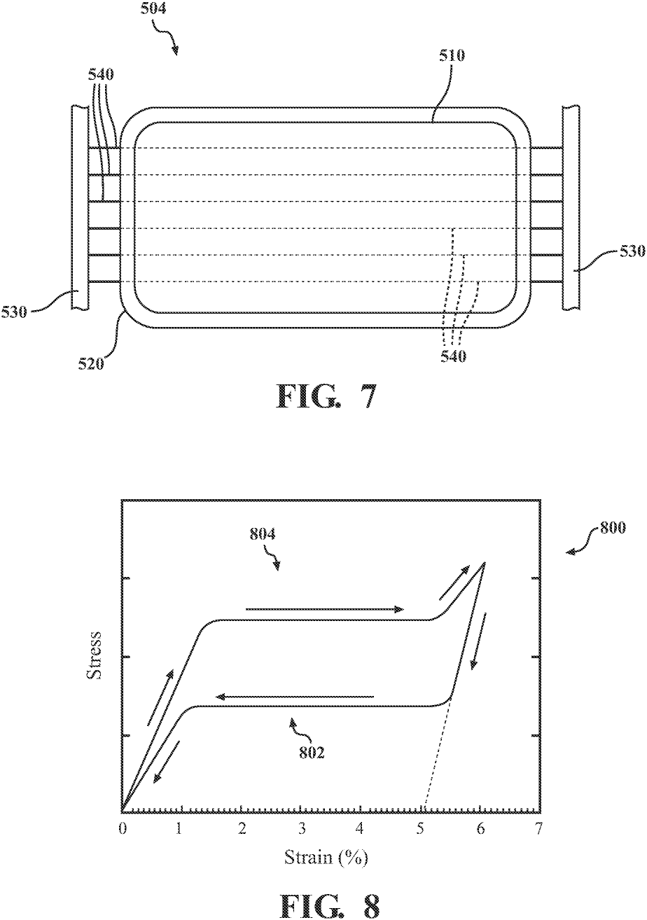

Referring to FIGS. 6-7, an example the seat portion 504 of the vehicle seat 500 is shown. FIG. 6 is an example of a cross-sectional elevation view of a seat portion 504 of the vehicle seat 500, and FIG. 7 shows a top view of the seat portion 504 of the vehicle seat 500.

The seat portion 504 can include a seat cushion 510. The seat cushion 510 can be made of any suitable material, now known or later developed. For instance, the seat cushion 510 can be made of a foam material. The seat cushion 510 can include an outer covering, such as fabric or leather. The seat cushion 510 can have any suitable size, shape, and/or configuration. In some arrangements, the seat cushion 510 can include bolsters.

The seat portion 504 can include a seat pan 520. The seat pan 520 can have any suitable size, shape, and/or configuration. As an example, the seat pan 520 can be a substantially U-shaped structure. The seat pan 520 can be oriented such that it opens in a substantially upward direction. The seat pan 520 can be made of any suitable material. In one or more arrangements, the seat pan 520 can be made of a rigid material. For example, the seat pan 520 can be made of metal or plastic.

In one or more arrangements, the seat pan 520 can at least partially support the seat cushion 510. In one or more arrangements, a portion of the seat cushion 510 can be received in the seat pan 520. In one or more arrangements, the seat pan 520 may not be attached to the seat cushion 510. In one or more arrangements, the seat pan 520 can be attached to the seat cushion 510. In one or more arrangements, a portion of the seat cushion 510 can be received in the seat pan 520.

The seat portion 504 can include a seat frame 530. The seat frame 530 can be made of any suitable material. In one or more arrangements, the seat frame 530 can be made of a rigid material. For example, the seat frame 530 can be made of metal or plastic. In some arrangements, the seat frame 530 can be part of or operatively connected to a vehicle frame member or to a vehicle floor.

In one or more arrangements, the seat frame 530 can at least partially support the seat pan 520. In one or more arrangements, a portion of the seat pan 520 can be received in the seat frame 530.

The seat frame 530 can have any suitable size, shape, and/or configuration. As an example, the seat frame 530 can be a substantially U-shaped structure. The seat frame 530 can be oriented such that it opens in a substantially upward direction. As another example, the seat frame 530 can be made of a plurality of individual posts.

The vehicle seat 500 can include one or more super elastic material members 540. In one or more arrangements, the super elastic material member(s) 540 can be super elastic wires.

The ends or end regions of the super elastic material member(s) 540 can be operatively connected to any suitable structure. For instance, the ends or end regions of the super elastic material member(s) 540 can be operatively connected to portions of the seat frame 530. The ends or end regions of the super elastic material member(s) 540 can be operatively connected to structures in any suitable manner, including by one or more fasteners, one or more adhesives, one or more welds, one or more forms of mechanical engagement, and/or one or more structures, just to name a few possibilities.

The super elastic material member(s) 540 can span across the seat frame 530 in any suitable manner. For instance, the super elastic material member(s) 540 can span across the seat frame 530 in a widthwise direction (corresponding to the left-right direction of the vehicle), in a lengthwise direction (corresponding to the front-back direction of the vehicle), in some other direction, or any combination thereof.

The seat pan 520 can be suspended on the super elastic material member(s) 540. In some arrangements, the seat pan 520 can be suspended exclusively on super elastic material member(s) 540. The super elastic material member(s) 540 can provide stiffness in support of the weight of a vehicle occupant sitting on the vehicle seat 500. In some arrangements, the seat pan 520 can be supported on the super elastic material member(s) 540 without any connection between them. In other arrangements, the super elastic material member(s) 540 can be operatively connected to the seat pan 520, such as by one or more fasteners, one or more adhesives, one or more welds, one or more forms of mechanical engagement, and/or one or more structures, just to name a few possibilities. In some arrangements, the super elastic material member(s) 540 can be connected to the seat pan 520 and/or the seat frame 530 so as to enable a user to adjust the tension of the super elastic material member(s) 540.

In other examples, the super elastic material member(s) 540 can be operatively connected to the seat pan 520 directly. For example, the super elastic material member(s) 540 can be operatively connected to a surface of the seat pan 520 by one or more fasteners, one or more screws, one or more nails, one or more adhesives, and/or one or more forms of mechanical engagement, or any combination thereof. As a result, the super elastic material member(s) 540 can directly contact the seat pan 520.

In some arrangements, the super elastic material member(s) 540 can be operatively connected to the seat frame 530 and/or the seat pan 520 such that the super elastic material member(s) 540 are stretched in tension. The tension of the super elastic material member(s) 540 can be varied in any suitable manner. In some examples, the super elastic material member(s) 540 can be pre-stretched before they are operatively connected to the seat frame 530 and/or the seat pan 520. In other examples, the super elastic material member(s) 540 can be operatively connected to the seat frame 530 and/or the seat pan 520 before being stretched. In some examples, the super elastic material member(s) 540 can be stretched, for example, by adjusting fasteners and/or by manual stretching.

In some examples, the super elastic material member(s) 540 can be stretched due to the weight of a person when the person sits on the vehicle seat 500. When a person sits on the vehicle seat 500, the downward load due to weight will stretch the super elastic material member(s) 540 to the quasi zero stiffness regime. As a result, most of the vibration will be isolated due to low stiffness.

When there is a plurality of the super elastic material members 540, the super elastic material members 540 can be substantially identical to each other, or one or more of the super elastic material members 540 can be different from the other super elastic material members 540 in one or more respects.

The super elastic material member(s) 540 can be arranged in various ways. A non-limiting example of one arrangement is shown in FIG. 7, which shows a top view of the seat portion 504. In one or more arrangements, a plurality of the super elastic material member(s) 540 can be arranged in a substantially parallel manner. In some arrangements, the super elastic material member(s) 540 can be substantially equally spaced from each other. In other arrangements, the super elastic material member(s) 540 can be non-equally spaced from each other. In some arrangements, two or more of the super elastic material member(s) 540 can cross each other. In some arrangements, the super elastic material member(s) 540 can be arranged in a serpentine manner.

The super elastic material member(s) 540 can be operatively connected to a power source (e.g., the power source(s) 140). The super elastic material member(s) 540 can be activated independently of each other. Alternatively or additionally, the super elastic material member(s) 540 can be activated together as a group.

The super elastic material member(s) 540 can be made of any suitable super elastic material. One example of a super elastic wire is AdrenaLine®, which is available from Miga Motor Company, Silverton, Oregon. Another example of a super elastic wire is Furukawa Ni-Ti Alloy, which is available from Furukawa Techno Material Co., Ltd., Kanagawa, Japan. In other examples, the super elastic material member(s) 540 can be a shape memory alloy.

A super elastic material is a material that exhibits two primary properties under certain conditions: superelasticity and quasi-zero stiffness. These properties are depicted in the stress-strain curve 800 shown in FIG. 8. Superelasticity refers to the ability of the super elastic material to substantially regain its original shape when an applied stress, load, and/or force, is removed. For example, the super elastic recovery region 802 of the stress-strain curve 800 shows the super elastic material returning to a zero-stress state after unloading of an applied stress. Quasi-zero stiffness refers to a region of the stress-strain curve 800 for super elastic materials that is substantially flat. In the quasi-zero stiffness region 804 of the stress-strain curve 800, the stiffness becomes very low (for example, zero or substantially zero), which allows for good vibration isolation. When the super elastic material member(s) 540 operate in the quasi-zero stiffness region 804, the transfer of vibrations from the vehicle (e.g., the floor) to the seat pan 520 can be substantially reduced. In this way, the super elastic material member(s) 540 can act as vibration isolators. The super elastic material member(s) 540 would exhibit a similar profile on a force-deflection curve. In the quasi-zero stiffness region, the force-deflection curve can become substantially flat.

While the super elastic material member(s) 540 are described herein as being a wires, it will be understood that the super elastic material member(s) 540 are not limited to being wires. In other examples, the super elastic material member(s) 540 can take the form of cables, tubes, and/or other structures, just to name a few examples. Additionally or alternatively, the super elastic material member(s) 540 may include an insulated coating.

It will be appreciated that arrangements described herein can provide numerous benefits, including one or more of the benefits mentioned herein. For example, arrangements described herein can isolate vibration from a vehicle floor to a vehicle seat. Arrangements described herein can improve comfort of an occupant of the vehicle seat. Arrangements described herein can use super elastic wires or cables, which can provide a lightweight construction.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of ... and ....” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope of the invention.

What is claimed is:

1. A system for adjusting vibration isolation for a vehicle seat, the system comprising:
a vehicle seat including a seat portion, the seat portion including:
a seat cushion; and
one or more shape memory material members, the seat cushion being supported by the one or more shape memory material members, the one or more shape memory material members being configured to have a selectively variable stiffness.

2. The system of claim 1, further including:
one or more processors operatively connected to selectively vary the stiffness of the one or more shape memory material members by controlling a temperature of the one or more shape memory material members.

3. The system of claim 2, further including:
one or more power sources operatively connected to supply electrical energy to the one or more shape memory material members, wherein the one or more processors are operatively connected to the one or more power sources, wherein the one or more processors are configured to control the temperature of the one or more shape memory material members by controlling the supply of electrical energy to the one or more shape memory material members based on one or more real-time conditions.

4. The system of claim 3, further including one or more sensors operatively connected to the one or more processors, wherein the one or more sensors are configured to acquire sensor data about a current temperature of the one or more shape memory material members, and wherein the one or more processors are configured to:
compare the current temperature of the one or more shape memory material members to a target temperature for the one or more shape memory material members to achieve a target stiffness profile for the one or more shape memory material members; and
when the current temperature of the one or more shape memory material members is different than the target temperature for the one or more shape memory material members, causing the supply of electrical energy to the one or more shape memory material members to be adjusted.

5. The system of claim 2, wherein the one or more processors are configured to selectively vary the stiffness of the one or more shape memory material members based on one or more real-time conditions.

6. The system of claim 5, further including one or more sensors operatively connected to the one or more processors, wherein the one or more sensors are configured to acquire sensor data about at least one of a weight of an occupant of the vehicle seat, vehicle speed, road vibration, and seat base vibration, wherein the one or more real-time conditions include at least one of the weight of an occupant of the vehicle seat, vehicle speed, road vibration, and seat base vibration.

7. The system of claim 1, wherein the one or more shape memory material members are a shape memory alloy.

8. A method for adjusting vibration isolation of a vehicle seat, the vehicle seat including a seat portion, the seat portion including a seat cushion and one or more shape memory material members, the seat cushion being supported by the one or more shape memory material members the method comprising:
selectively varying a stiffness of the one or more shape memory material members.

9. The method of claim 8, wherein selectively varying the stiffness of the one or more shape memory material members includes controlling a temperature of the one or more shape memory material members.

10. The method of claim 9, wherein controlling the temperature of the one or more shape memory material members includes controlling a supply of electrical energy to the one or more shape memory material members.

11. The method of claim 10, further including:
determining a target temperature for the one or more shape memory material members to achieve a target stiffness profile for the one or more shape memory material members;
comparing a current temperature of the one or more shape memory material members to the target temperature for the one or more shape memory material; and
when the current temperature of the one or more shape memory material members is different than the target temperature for the one or more shape memory material members, causing the supply of electrical energy to the one or more shape memory material members to be adjusted, whereby the stiffness of the one or more shape memory material members is selectively varied.

12. The method of claim 8, wherein selectively varying the stiffness of the one or more shape memory material members is based on one or more real-time conditions.

13. The system of claim 5, wherein the one or more real-time conditions include at least one of a weight of an occupant of the vehicle seat, vehicle speed, road vibration, and seat base vibration.

14. A system for vibration isolation of a vehicle seat comprising:
a vehicle seat including a seat pan; and
one or more super elastic wires, the one or more super elastic wires being operatively connected to one or more structures such that the seat pan is suspended on the one or more super elastic wires.

15. The system of claim 14, wherein the one or more super elastic wires are configured such that, when a person sits on the vehicle seat, the one or more super elastic wires are stretched to a quasi-zero stiffness regime.

16. The system of claim 14, wherein the one or more super elastic wires are operatively connected in tension to the one or more structures.

17. The system of claim 14, wherein the one or more super elastic wires is a plurality of super elastic wires, and wherein the plurality of super elastic wires are arranged in a plurality of rows.

18. The system of claim 14, wherein the one or more structures are a seat frame.

19. The system of claim 14, wherein the one or more super elastic wires are made of a shape memory alloy.

20. The system of claim 14, wherein the seat pan is suspended exclusively on the one or more super elastic wires.
